(19) United States
(12) Patent Application Publication
(10) Pub. No.: US 2014/0297006 A1
(43) Pub. Date: Oct. 2, 2014

(54) SYSTEM AND METHOD FOR PROVIDING PHYSIOLOGICAL FEEDBACK AND REWARDS FOR ENGAGING USER AND RETENTION OF CUSTOMER

(71) Applicant: Rajendra Padma SADHU, Somerset, NJ (US)

(72) Inventor: Rajendra Padma SADHU, Somerset, NJ (US)

(21) Appl. No.: 14/041,730

(22) Filed: Sep. 30, 2013

Related U.S. Application Data
(63) Continuation-in-part of application No. 13/105,925, filed on May 12, 2011, now Pat. No. 8,568,313.
Application No. 13/105,925 is a continuation-in-part of application No. 12/722,554, filed on Mar. 12, 2010.

(51) Int. Cl. G06K 9/00

(52) U.S. Cl. CPC G06K 9/00342
USPC 700/91

(57) ABSTRACT

A system and method for providing physiological feedback and rewards for engaging a user and retaining a customer. The system includes one or more sensors for collecting physiological data from the user and transmitting through a user wearable portable communication unit over a voice or data communication network, a web based server unit in communication with one or more user wearable portable communication units through the data communication network for receiving the physiological data transmitted by the one or more sensors and to further: generate a credit for the physiological data collected from the one or more users based on predefined parameters and transmitting health based feedback to the one or more user wearable portable communication units, whereby the generated credit updated in the registered user account and receive a current geographical location of the one or more user wearable portable communication units for transmitting location based rewards to the one or more user wearable portable communication units and update the transmitted rewards in the registered user account.

### TECHNICAL FIELD

The present disclosure generally relates to a user wearable portable communication device which is described briefly in prior art Ser. No. 13/105,925. More particularly the present disclosure relates to a system and method for providing physiological feedback and rewards for engaging user and retention of customer.

### BACKGROUND

Presently, devices like panic buttons used in emergencies interlink the user to the emergency response team via a landline or mobile telephone. But, if the user is suddenly disabled during a sudden health crisis, such as in a heart attack or a serious fall situation, the panic-button type devices become useless. Further if the person is able to press the button the person should be within the effective wireless transmission distance to the device that dials the telephone to report the emergency. The panic button type devices are not effective when the users are in an unconscious state or rendered incapacitated by a fall or other medical condition. Furthermore no vital information on the user's status like heart rate, blood pressure, breath rate, body temperature, oxygen level and the like will be transmitted to the response team to provide further medical assistance. Consequently, it is difficult for the response team to diagnose and provide treatment to the user.

Typically, the health monitoring systems should have an adjustable emergency alert level throughout a day for different levels of activity. The capacity to determine the location of the person who requires immediate medical assistance should be more effective, accurate, and relevant to provide proper medical assistance. Global positioning systems (GPS) determine the location of the user when signals from multiple GPS satellites are received. However, GPS fails to determine the location of the user when signals are not received from more than one satellite due to shielding by buildings, geographic features, or improper antenna orientation. The conventional GPS tracking systems comprises multiple integrated circuit chips. Consequently, the multiple integrated circuit chips consume more power as compared to the single integrated circuit chips with the combined capabilities of the individual integrated circuit chips. Furthermore, the conventional GPS receivers can determine the location of the user only when there is clear view of the sky within several feet of the GPS receiver's antenna.

Typically, many health care facilities perform the vital sign monitoring of the user only once in a week due to the time and money needed to perform these operations. If the user's vital signs are checked only once in a week, the declining health condition of the user is detected after the health condition is worsened. Furthermore, this eliminates the opportunity for early intervention. The user's physiological parameters such as pulse rate, heart beat rate, electrocardiogram (EKG), blood pressure, breathing rate, body temperature and the like should be measured and monitored continuously. Further, the measured parameters and the location of the user should be transmitted to the central monitoring system to continuously monitor the physiological parameters of the user while simultaneously tracking the location of the user.

Further, the conventional devices such as fitness watches, heart rate monitors, GPS-enabled fitness monitors, health monitors (e.g., diabetic blood sugar testing units), digital voice recorders, pedometers, altimeters, and other conventional personal data capture devices are generally manufactured for conditions that occur in a single or small groupings of activities. Problematically though, conventional devices do not provide effective solutions to users in terms of providing a comprehensive view of one's overall health or wellness as a result of a combined analysis of data gathered. This is a limiting aspect of the commercial attraction of the various types of conventional devices listed above. Generally, if the number of activities performed by conventional personal data capture devices increases, there is a corresponding rise in design and manufacturing requirements which results in significant consumer expense, and eventually becomes prohibitive to both investment and commercialization.

Further, often times people purchase diagnostic devices with sensors either in patch format, body worn, stand alone, or fixed format, but do not use them due to the monthly subscription costs. This makes it a difficult value proposition for reducing churn rates, and for patient engagement/customer retention to effectively provide service to the customer. Thus, rewarding the user based on the usage, and providing cash incentives based on the usage will lead to higher customer retention and patient engagement for the betterment of health. Customers can get rewards from providers like insurance companies, monitoring companies, hospitals, and pharmacies based on these rewards. This automatic and continuous data from the user through the wearable device from the sensors will provide a value add to both the customer and provider.

Furthermore, identifying the target customer as and when they become a potential customer, engaging the customer, and retaining the customer are the key challenges that many businesses face. By automatically analysing the vitals system can automatically identify the potential customer, engage the customer to treat their health with the right diagnosis, and provide health tips that are the key for early intervention. Often people neglect to enroll into monitoring services due to the costs associated with it. Thus, providing discounts based on the usage may help them lower their monthly subscription cost and stay healthy. In addition, pharmacy stores would like to identify the potential customer based on the drugs they are selling, and vitals are the key resources in identifying the right customers. By providing discounts, pharmacy stores can stay in business while serving the customer. Insurance companies would also like to reduce hospital readmission, and thus identifying the customer when the health starts declining to provide the right diagnosis will help them reduce the cost of the claims. As a result, providing discounts to customers who enroll into remote health monitoring will lower these costs as well. Additionally, patients who live in remote places would like to monitor their health at home without incurring additional costs that may include travel to hospital, doctor office, or even paying the co-pay. Finally, automatically informing the pharmacy when it's time to refill the prescription drugs and providing that information right onto a patient user wearable device will help better manage the medication. Medication alarms onto the user wearable device will help the patient from missing the dosage.

In commercial terms there are many different ways that businesses advertise including but not limited to rewards, points, bonus, score, and value-adds, which all have similar meaning. For the scope of this artwork we would like to define these as rewards.

Moreover, conventional manufacturing techniques are often limited and ineffective at meeting increased requirements to protect sensitive hardware, circuitry, and other components that are susceptible to damage, but which are required to perform various personal data capture activities. As a conventional example, sensitive electronic components such as printed circuit board assemblies (“PCBA”), sensors, and computer memory (hereafter “memory”) can be significantly damaged or destroyed during manufacturing processes where over mouldings or layering of protective material occurs using techniques such as injection moulding, cold moulding, and others. Damaged or destroyed items subsequently raises the cost of goods sold and can deter not only investment and commercialization, but also innovation in data capture and analysis technologies, which are highly compelling fields of opportunity.

In light of aforementioned discussion there exists a need of a user wearable portable communication unit used to score and provide feedback, alerts, rewards and coupons based on the locations for performing the health related activities by utilizing the corresponding user wearable portable communication unit.

### BRIEF SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

A more complete appreciation of the present disclosure and the scope thereof can be obtained from the accompanying drawings which are briefly summarized below and the following detailed description of the presently preferred embodiments.

Exemplary embodiments of the present disclosure are directed towards a system for providing physiological feedback and rewards to a user. According to a first aspect, the system includes one or more sensors collecting physiological data from the user and transmitting through a user wearable portable communication unit over a voice or data communication network. The data corresponding to the health related tasks accomplished by the user and the physiological data dynamically uploaded to a web based server unit for storing and viewing on a registered user account or providing to another system for rewarding the customer based on his data.

According to the first aspect, the system includes a web based server unit in communication with the user wearable portable communication unit through a data communication network for receiving the physiological data transmitted by the one or more sensors and to further generate a credit for the physiological data collected from the one or more users based on predefined parameters and transmitting health based feedback to the one or more user wearable portable communication units and the generated credit updated in the registered user account.

According to the first aspect, the system includes a web based server unit in communication with the user wearable portable communication unit through a data communication network for receiving the physiological data transmitted by the one or more sensors and to further receive a current geographical location of the one or more user wearable portable communication units for transmitting location based rewards to the one or more user wearable portable communication units and update the transmitted rewards in the registered user account. The web based server unit provides the registered account's data on receiving a request from an external data communication system coupled to the web based server unit.

According to the first aspect, the system includes a data repository unit in communication with the web based server unit for storing the data received from the user wearable portable communication unit, this data includes but not limited to credits generated for the one or more health related tasks accomplished by the user and the physiological feedback and rewards transmitted to the user wearable portable communication unit.

According to a second aspect, a method for providing physiological feedback and rewards to a user is disclosed. According to the second aspect the method includes detecting one or more health-related tasks accomplished by the user and collect physiological data of the user from one or more sensors for transmitting through a user wearable portable communication unit to a web based server unit, whereby a data corresponding to the health related tasks accomplished by the user and the physiological data dynamically uploaded to a registered user account maintained in a data repository unit.

According to the second aspect, the method includes generating a rating for the one or more health related tasks accomplished by the user and transmitting health based feedback to the user wearable portable communication unit. The generated rating updated in the registered user account by a web based server unit in communication with the user wearable portable communication unit through a voice or data communication network.

According to the second aspect, the method includes receiving a current geographical location of the user wearable portable communication unit by the web based server unit for transmitting location based rewards to the user wearable portable communication unit and update the transmitted rewards in the registered user account.

According to the second aspect, the method includes storing the physiological data received from the one or more user wearable portable communication unit, credit generated for the one or more health related tasks accomplished by the user, and the physiological feedback, and rewards transmitted to the user wearable portable communication unit in a data repository unit in communication with the web based server unit.

### BRIEF DESCRIPTION OF DRAWINGS

Other objects and advantages of the present disclosure will become apparent to those skilled in the art upon reading the following detailed description of the exemplary embodiments, in conjunction with the accompanying drawings, wherein like reference numerals have been used to designate like elements, and wherein:

FIG. 1 illustrates a block diagram of a system for providing physiological feedback and rewards to a user.

FIG. 2 illustrates a diagram establishing a communication between a user wearable portable communication unit and a web based server unit.

FIG. 3 illustrates a diagram establishing a communication between a web based server unit and a web portal in accessing a corresponding user account for visualizing the updates transmitted to the registered user account.

FIG. 4 illustrates a diagram establishing a communication between a web based server unit and a mobile application integrated within the mobile device of a user in accessing a corresponding user account for visualizing the updates transmitted to the registered user account.

FIG. 5 is an exemplary user interface displaying the credits awarded to the each individual health related task accomplished by the user.

FIG. 6 is a block diagram illustrating the rewards provided to the user accessing the web portal.

FIG. 7 is a flow diagram illustrating the method to provide feedback and rewards for one or more health-related tasks.

FIG. 8 is a flow diagram illustrating the process of rebates program.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

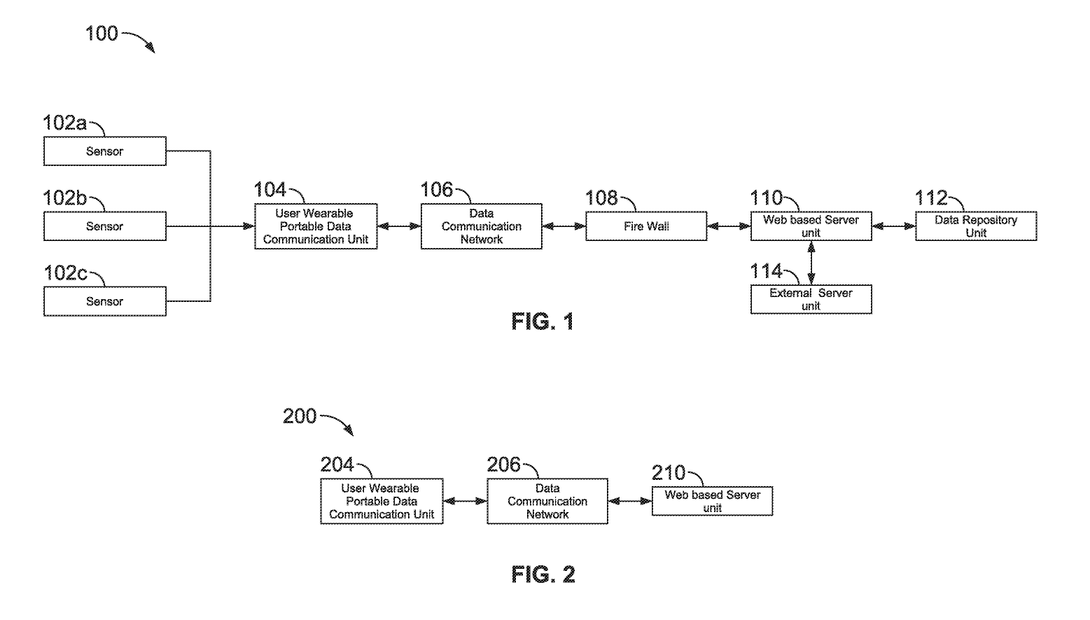

FIG. 1 illustrates a block diagram 100 of a system for providing physiological feedback and rewards to a user. The system 100 includes a user wearable portable communication unit 104, multiple sensors 102a, 102b and 102c, a data communication network 106, a firewall 108, a web based server unit 110, a data repository unit 112 and an external server unit 114. The user wearable portable communication unit 104 may include but not limited to a hand watch, a wrist band, a band, mobile phone, smart phone, PDA, iPad, iPhone and the like worn as a strap or band around an arm, leg, ankle or any other bodily appendage or feature. For convenience, system 100 is discussing three sensors 102a, 102b and 102c. However it should be understood that in practise there may be any number of sensors as similar as the sensors 102a, 102b and 102c and it could be in a patch or body worn or fixed or portable format, which can be included in the system. Therefore the present disclosure is not limited in the number of sensors that may be included and/or supported by a user wearable portable communication unit consistent with the disclosed embodiments.

As shown in FIG. 1, the sensors 102a, 102b and 102c in communication with the user wearable portable communication unit 104 configured to detect the health related tasks accomplished by a user and to collect the physiological data of the user. The health related tasks may include but not limited to a two mile walk by a user computed based on the coordinates of a global positioning system or input from pedometer or like devices, regular check-up of blood pressure, check-up of electrocardiography, check-up of pulse rate and oxygen level in blood, regular check-up of heart rate, body weight check-up, fatal heart rate check-up, and providing acknowledgement to multiple medicine reminders per day, number of visits to a doctor, diet control and the like. Though not depicted in FIG. 1, the communication established between the sensors 102a, 102b and 102c and the user wearable portable communication unit can be a short range communication network like Bluetooth™, ZigBee™, ANT™, ANT+™, Wifi, near field communication, radio communication and the like, which may be wired communication network or a wireless communication network. The health related tasks and the physiological data detected by the sensors 102a, 102b and 102c are transmitted to a web based server unit 110 to store in a data repository unit 112 for dynamically uploading and displaying the credits of the user on a registered user account based on a predefined set of data communication protocols.

As further shown in FIG. 1, the web based server unit 110 in communication with the user wearable portable communication unit 104 through a data communication network 106 configured to store the list of health related tasks accomplished by vitals of the corresponding user. For convenience, the system 100 is discussing only about the communication established between a web based server unit 110 and only a one user wearable portable communication unit 104. However it should be understood that in practise there may be any number of user wearable portable communication units as similar as the present disclosed user wearable portable communication unit 104, which can be included in the system. Therefore the present disclosure is not limited in the number of user wearable portable communication unit that may be included and/or supported by the system with the disclosed embodiments. Also further, a firewall 108 is positioned between the data communication network 106 and the web based server unit 110 to provide a secure internal network for controlling the incoming and outgoing network traffic by analyzing the data packets and determining whether to allow the data or not based on the predetermined protocols. It should be understood that the firewall 108 used in the system 100 may be a software or hardware-based network security system.

Moreover, the web based server unit 110 configured to generate credits which may include but not limited to ratings, points, score, results and the like corresponding to physiological data collected from the users based on predefined parameters for transmitting health based feedback to the user wearable portable communication unit 104 in accordance with few limitations and the generated credits are dynamically uploaded in the registered user account stored in the data repository unit 112. The limitations differ from each health related task, where the credits for each task can be limited once a day, or per day, or in a day with predetermined hours of gap. The credits generated for each of the health related tasks can be, for every two miles of walk per a day the credit is generated as two, for every day check-up of blood pressure the credit is generated as two and is limited as one credit per day, and for every day check-up of electrocardiography using a portable electrocardiography device the credit is generated as three and is limited as two credits per day and there should be a minimum of predefined hours which may include but not limited to six, seven and eight hours of gap between each upload. Similarly, for every day check-up like body temperature, heart rate, pulse rate, body weight, blood sugar levels, fatal Doppler and breath rate are also generated with predetermined credits. Further, the generated credits for each health related task performed per day are computed for every month and the monthly credits are used to provide rewards for the corresponding user in or around the current geographical location, online stores, or at any participating store.

Further, the web based server unit 110 configured to compute the credits generated for each and every health related task accomplished by the user for generating feedback and rewards to the user wearable portable communication unit 104. The feedback generated to the accomplished health related tasks may include but not limited to a health-related tips, discounts, coupons, advertisements from nearby stores, offers at nearby stores, alerts and the like. The web based server unit 110 in communication with the user wearable portable communication unit 104 through a data communication network 106 configured to receive a current geographical location of the user wearable portable communication unit 104 for transmitting location based rewards to the user wearable portable communication unit 104 and update the transmitted rewards in the registered user account stored in the data repository unit 112. The web based server unit 110 provides the registered account's data on receiving a request from an external data communication system coupled to the web based server unit 110. The web based server unit 110 is further loaded with a software program, which includes a logic to compute the generated credits, earnings, rewards, score and points based on predefined or dynamically defined protocols for a given data input. The web based server unit 110 is also configured to perform a lookup into another web based server unit or a data repository unit for the credits based on a specific input. The web based server unit 110 could be individual server or a cluster of web servers may include but not limited to one to n number of web based server units depending on the usage of servers by the users. Also further, the external server unit 114 in communication with the web based server unit 110 through an application programming interface configured to receive the data related to the corresponding user based on the predefined credentials for transmitting the predefined credentials based rewards stored in the external server unit 114 to the users. The predefined credential based rewards stored in the external server unit 114 may include but not limited to insurance company, Pharmacy Company and the like.

Moreover the data communication network 106 used to communicate the web based server unit 110 and the user wearable portable communication unit 104 may include but not limited to a cellular communication network, wireless communication network and the like. The cellular communication network is used to establish a communication by utilizing the http based application layer and https application layer for accessing the web based server unit 110 and also the user wearable portable communication unit 104. Further the cellular communication network may include technologies but not limited to a global system for mobile communication, general packet radio service, third generation, fourth generation and the like. Similarly, the wireless communication network may include but not limited to a wireless local area network, wireless wide area network, and the like.

Further as shown in FIG. 1, the data repository unit 112 included in the system 100 is used to communicate with the web based server unit 110 for storing the content representing credentials of the corresponding user which may include but not limited to a name, mail id, address, registered account number, emergency contacts, past medical history, reference number and the like. The data repository unit 112 further configured to store the physiological data transmitted from the user wearable portable communication unit 104, credits generated for the health related tasks accomplished by the user and the physiological feedback and rewards transmitted to the user wearable portable communication unit 104. Further, the user wearable portable communication unit 104 is also configured to transmit the parameters accomplished by the portable device to the web based server unit 110 which may include but not limited to a location, vitals, events, SOS, low battery indication, dialled calls, received calls, accelerometer data, data collected from various sensors 102a, 102b and 102c, activity data, electronic video, medical data and the like.

FIG. 2 illustrates a diagram 200 establishing a communication between an exemplary user wearable portable communication unit consistent with the disclosed embodiments and a web based server unit. For convenience, the present figure and specification is used to exclusively describe the process of establishing a communication between the user wearable portable communication unit 204 and the web based server unit 210 through a data communication network 206. However it is understood that the web based server unit 210 is not only limited to communicate with the user wearable portable communication unit 204 but also configured to communicate with multiple similar user wearable portable communication units.

As shown in FIG. 2, the user wearable portable communication unit 204 is used to accomplish the parameters associated with the corresponding portable device. The parameters may include tracking the location, determining the vitals, accomplishing the predetermined events, detecting the SOS event, indicating the low battery, listing the number of calls dialled and received, accelerometer data, collecting data from various sensors, activity data, electronic video and medical data and the like. The web based server unit 210 configured to compute the credits generated for each individual health related task accomplished by the user. The web based server unit 210 in communication with the user wearable portable communication unit 204 configured to receive the current geographical location through a data communication network 206 for transmitting the location based rewards to the user wearable portable communication unit 104 and update the transmitted rewards in the registered user account stored in a data repository unit. The user wearable portable communication unit 204 is configured to collect the data corresponding to the multiple vitals of the user and transmit the collected data to the web based server unit 210 for receiving the health based feedback which may include data related to health related tips, medical suggestions and the like to modulate the vitals into a better way.

Furthermore as shown in FIG. 2, the user wearable portable communication unit 204 configured to transmit the computed SOS event, indication of low battery, number of calls made and received by the user to the web based server unit 210 for providing the related rewards to the accomplished data. The user wearable portable communication unit 204 is further configured to collect the accelerometer data, data received from multiple sensors, electronic video and medical data are also further transmitted to the web based server unit 210 for receiving the feedback which may include health related tips, discounts, coupons, advertisements at nearby stores, offers provided at nearby stores, alerts, rewards and the like based on the credits generated for the accomplished data.

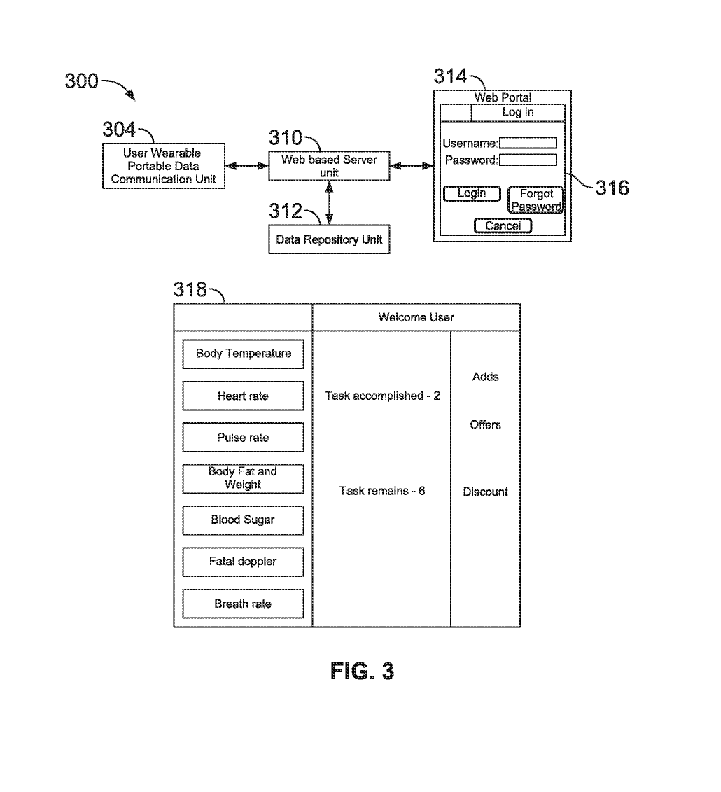

FIG. 3 illustrates a diagram 300 establishing a communication between a web based server unit and a web portal in accessing a corresponding user account for visualizing the updates transmitted to the registered user account. As shown in FIG. 3, user wearable portable communication unit 304 communicates with the web based server unit 310 through a data communication network for transmitting the accomplished health-related tasks described in the FIG. 1 and the parameters described in the FIG. 2. As described above in FIG. 1, the web based server unit 110 in the FIG. 3 is referred as 310 and is used to store the list of health related tasks accomplished by the user and generate credits to the health related tasks accomplished by the user for transmitting health based feedback to the user wearable portable communication unit 304.

As shown in FIG. 3, the web portal 314 is an application may be downloaded in a portable communication device, tablet, smartphone and the like for accessing the corresponding user account from any geographical location. The web portal 314 provides an overview of a first user interface 316 for logging into the account after being a secure member of the web portal 314. The first user interface 316 includes a login page, where the user is enabled to provide a secured username and password for accessing there corresponding user accounts. Further the login page also includes a cancel option and forgot password option to cancel the access for the account and to get back the new password in case of forgot password. The user registered with the application is enabled to provide the personalized credentials which may include but not limited to device number, mail id, name, remainder questions for password, address, registered account number, emergency contacts, past medical history, reference number and the like. The credentials provided are securely transmitted to the web based server unit 310 for storing in the data repository unit 312.

Furthermore as shown in FIG. 3, the user logged into the corresponding user account is provided with a second user interface 318, where the user is provided with a list of health related tasks, the tasks accomplished by the user and the tasks which are to be accomplished by the user. Also the second user interface 318 is disclosed with the content related to the advertisements, offers at nearby store, discounts at nearby store and the like of the current geographical location of the user. The above list of health related tasks required to be accomplished and the health related tasks accomplished by the user, and the content related to advertisements, offers, discounts, rewards and the like are simultaneously transmitted to the user wearable portable communication unit 304 and to the registered user account.

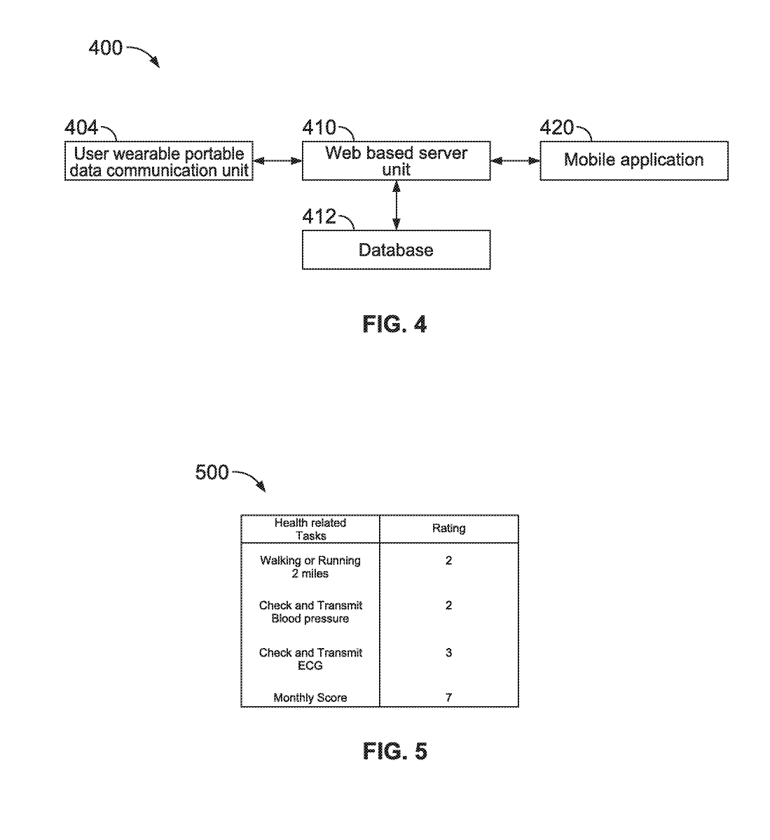

FIG. 4 illustrates a diagram 400 establishing a communication between a web based server unit and a mobile application integrated within the mobile device of a user in accessing a corresponding user account for visualizing the updates transmitted to the registered user account. As shown in FIG. 4, user wearable portable communication unit 404 communicates with the web based server unit 410 through a data communication network for transmitting the accomplished health-related tasks described in the FIG. 1 and the parameters described in the FIG. 2. As described above in FIG. 1, the web based server unit 110 in the FIG. 4 is referred as 410 and is used to store the list of health related tasks accomplished by the user and generate credits to the health related tasks accomplished by the user for transmitting health based feedback to the user wearable portable communication unit 404.

As shown in FIG. 4, the mobile application 420 may be downloaded in a portable communication device, tablet, smartphone and the like for accessing the corresponding user account from any geographical location. The mobile application 420 provides an overview of an interface for logging into the account after being a secure member of the application downloaded in the portable communication device. The user interface including a login page, where the user is enabled to provide a secured user name and password for accessing there corresponding user account. The user registered with the application is enabled to provide the personalized credentials which may include but not limited to device number, mail id, name, remainder questions for password, address, registered account number, emergency contacts, past medical history, reference number and the like. The credentials provided are securely transmitted to the web based server unit 410 for storing in the data repository unit 412.

Furthermore as shown in FIG. 4, the data collected by the user wearable portable communication unit 404 is also stored in the data repository unit 412 and displayed over the mobile application downloaded in the portable communication device. The user logged into the corresponding user account is able to visualize the data displayed over the mobile application performing web services to the web application and in turn connected to the data repository unit 412. For example, many physicians at remote health monitoring centre are able to visualize the data through there secured logins and are also able to set thresholds on the data relayed from sensors. Thus, if the data is over the range of the predetermined thresholds set by the physicians, alerts are sent to care givers, physicians and users. The corresponding data transmitted to physicians is reviewed, and a feedback is provided back to the patient through the mobile application 420 downloaded in the corresponding portable communication device of the user.

Moreover as shown in FIG. 4, the user wearable portable communication unit 404 can also be used in hospitals by the nurses, sisters, care takers and the like to report in any emergency of patients. The emergency of patients can be like, when they fell in bathrooms or if they want to report in any emergency and there is no one beside them to inform the concerned caretaker or doctor and the like. Also further, the user wearable portable communication unit 404 along with sensors can be used by patients and the data transmitted by patients is remotely monitored from the central station by nurse or caretaker and the like.

FIG. 5 is an exemplary user interface 500 displaying the credits awarded to the each individual health related task accomplished by the user. The user interface displayed in FIG. 5 is an exemplary credits provided to the each individual task accomplished by the user. For example, if the user has accomplished the task of walking/running for two miles the credit is generated as two. Similarly if the blood pressure is checked by the user and transmitted to the corresponding user wearable portable communication unit the credit is provided as two and if the electrocardiography is checked and transmitted to the corresponding user wearable portable communication unit the credit is provided as three. Similarly each individual health related task accomplished by the user is given a unique credit. The rated tasks are computed for every month to provide rewards based on the credits. Further the user is also provided with an immediate feedback based on the credit provided for each task per day. The finally computed credit generates rewards, which are displayed over the corresponding user wearable portable communication unit and transmitted to the registered user account. The rewards provided to the user can be redeemed at any pharmacy, monthly subscription and at any participating store and the like.

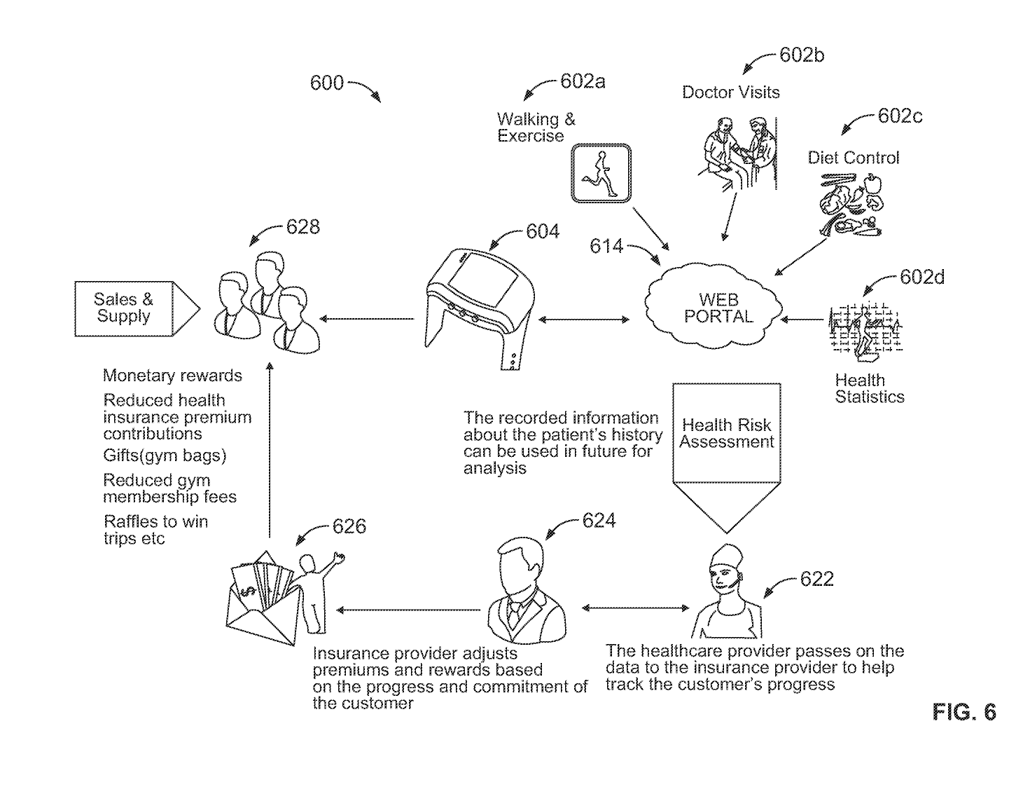

FIG. 6 is a block diagram 600 illustrating the reward program provided to the user accessing a web portal. According to a non limiting exemplary embodiment of the present disclosure, as shown in FIG. 6, the health or activity related tasks accomplished by the user which may include but not limited to walking and exercise 602a, number of visits to doctor 602b, diet control 602c, health statistics 602d, physiological data sent from the sensors, data calculated using the sensor data based on certain rules, data from the home monitoring sensors and the like. The list of accomplished health related tasks and the rewards provided for the accomplished tasks are displayed over the web portal 614, which can also be an application downloaded in a portable communication device, tablet, smartphone and the like for accessing the corresponding user account from any geographical location.

As shown in FIG. 6, the user wearable portable communication unit 604 in communication with the web portal 614 is used to transmit the rewards provided for the health related tasks accomplished by the user for displaying over the user wearing user wearable portable communication unit 604. The data provided over the web portal 614 is stored in a data repository unit for further analysis of the data. The user registered with the corresponding web portal is enabled to login with a secured user name and password for accessing their corresponding user account. The user logged into the corresponding user account is able to visualize the data displayed over the web portal 614. The user logged-in over the web portal may be a normal user accomplishing the health related task or a physician or care taker and the like.

Further as shown in FIG. 6, for example if the user logged in is a physician. Then many of the physicians at remote health monitoring centre are able to visualize the data through their secured logins and are also able to set thresholds on the data relayed from sensors. Thus, if the data from sensors is not within the range of the predetermined thresholds set by the physician's alerts are sent to care givers, physicians, care givers, loved ones and users. The corresponding data transmitted to physicians is reviewed, and a feedback is provided back to the patient through the web portal 614 downloaded in the corresponding portable communication device of the user. If the alerts are transmitted to a care taker 622, the care taker 622 is able to monitor the patient or the corresponding user to receive tips or suggestions and the like for the progress in the health of the user.

Moreover as shown in FIG. 6, the care provider 622 further transfers the data to an insurance provider 624 to reward and motivate the user by tracking the progress of the users. The insurance provider 624 adjusts the premium and rewards based on the progress and commitment of the user to stay healthy. Further as shown in FIG. 6, the rewards which may include but not limited to monetary rewards, reduced health insurance premium contributions, gifts such as gym bags, reduced member ship fees for gym, raffles to win trips and the like as shown in 626 provided by the stake holders and are updated to the respective user 628 on the respective account in web portal 614.

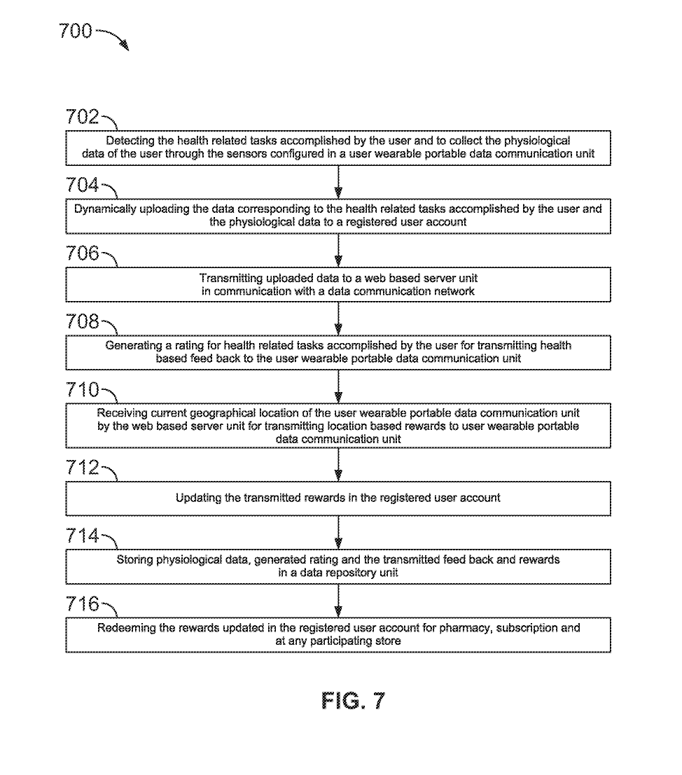

FIG. 7 is a flow diagram 700 illustrating the method to provide feedback and rewards for one or more health-related tasks. According to an exemplary method, at 702 the health related tasks accomplished by the user and the physiological data collected by the user are detected by the sensors in communication with the corresponding user wearable portable communication unit. The detected content corresponding to the health related tasks and the physiological data are dynamically uploaded to a registered user account at 704. The content uploaded at 704 is transmitted to a web based server unit in communication with the user wearable portable communication unit through a data communication network at 706.

Further, at 708 the transmitted content may include the health related tasks accomplished by the user for generating a credit and transmitting the health based feedback to the user wearable portable communication unit and further updated in the registered user account. At 710 the web based server unit configured to receive the current geographical location of the user wearable portable communication unit for transmitting the location based rewards to the user wearable portable communication unit and update the transmitted rewards in the registered user account at 712. Further the physiological data transmitted from the user wearable portable communication unit, generate credits for the health related tasks accomplished by the user and transmits the physiological feedback and rewards to the user wearable portable communication unit stored in a data repository unit at 714. Thus the transmitted rewards are updated in the registered user account and redeemed by the user at pharmacy store, monthly subscription and at any participating store and the like at 716.

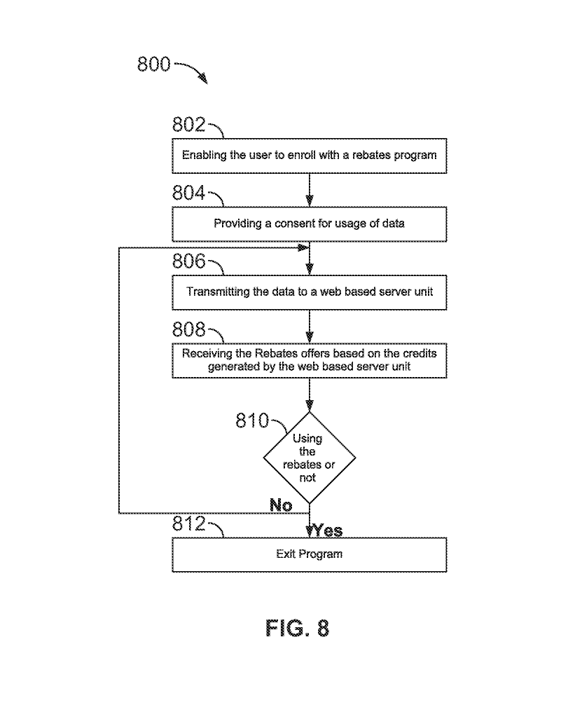

FIG. 8 is a flow diagram 800 illustrating the process of rebates program. According to an exemplary embodiment, the user is enabled to enroll into the rebates program provided at 802. The user enrolled at 802 is enabled to provide consent for utilizing the data at 804. The data may include but not limited to the health related tasks accomplished by the user. The accomplished data is sent to the web based server unit at 806 from the corresponding user wearable portable communication unit to receive the offers based on the credits generated by the web based server unit at 808. Further at 810 the offers received by the user can be redeemed or not, if received rebate offers are used the user is able to exit the program at 812 or else the user continues at 806.

While specific embodiments of the invention have been shown and described in detail to illustrate the inventive principles, it will be understood that the invention may be embodied otherwise without departing from such principles.

What is claimed is:

1. A system for providing physiological feedback and rewards for engaging a user, the system comprising:
one or more sensors collecting physiological related data from the user and transmitting through a user wearable portable communication unit over a communication network;
a web based server unit in communication with one or more user wearable portable communication units through the communication network and receiving the physiological data transmitted by the one or more sensors and to further:
generate a credit for the physiological data collected from the one or more users based on predefined parameters and transmitting health based feedback to the one or more user wearable portable communication units, whereby the generated credit is updated in a registered user account; and
receive a current geographical location of the one or more user wearable portable communication units and transmitting location based rewards to the one or more user wearable portable communication units and update the transmitted rewards in the registered user account, whereby the web based server unit provides the registered account's data on receiving a request from an external data communication system coupled to the web based server unit; and
a data repository unit in communication with the web based server unit and storing the physiological data received from the one or more user wearable portable data communication units, credit generated for one or more health related tasks accomplished by the user, the health based feedback, and rewards transmitted to the user wearable portable communication unit.

2. The system of claim 1, wherein the web based server unit is configured to compute the credits generated for the one or more health related tasks accomplished by the user.

3. The system of claim 1, wherein the web based server unit in communication with the one or more user wearable portable communication units transmits coupons; alerts; feedback; and rewards to the registered user account based on the current geographical location of the user.

4. The system of claim 1, wherein the web based server unit in communication with the one or more user wearable portable communication units displays coupons; alerts; feedback; and rewards on the registered user account based on the current geographical location of the user.

5. The system of claim 1, wherein the web based server unit loaded with a software program is configured to calculate the credits based on the data received from the one or more sensors either internally; and from the external data communication system.

6. The system of claim 1, wherein the user wearable portable communication unit is configured to transmit one or more parameters or events accomplished by utilizing the user wearable portable communication unit to the web based server unit.

7. The system of claim 1, wherein the user wearable portable communication unit communicates with the web based server unit based on a predefined data communication protocol.

8. A method for providing physiological feedback and rewards for engaging a user, the method comprising:
detecting one or more health-related tasks accomplished by the user and collect physiological data of the user from one or more sensors for transmitting through a user wearable portable communication unit to a web based server unit, whereby a data corresponding to the health related tasks accomplished by the user and the physiological data are dynamically uploaded to a registered user account maintained in a data repository unit;
generating a rating for the one or more health related tasks accomplished by the user and transmitting health based feedback to the user wearable portable communication unit, whereby the generated rating is updated in the registered user account by a web based server unit in communication with the user wearable portable communication unit through a communication network;
receiving a current geographical location of the user wearable portable communication unit by the web based server unit for transmitting location based rewards to the user wearable portable communication unit and updating the transmitted rewards in the registered user account; and
storing the physiological data received from the one or more user wearable portable communication units, credit generated for the one or more health related tasks accomplished by the user, and physiological feedback, and rewards transmitted to the user wearable portable communication unit in a data repository unit in communication with the web based server unit.

9. The method of claim 8, further comprising a step of enabling the user to enroll for a rebate program for enabling a transmission of rebate offers to the user wearable portable communication unit based on the credits generated for the one or more health related tasks accomplished by the user.

10. The method of claim 8, further comprising a step of determining an ability of the user to achieve a targeted level of health by accomplishing one or more health related tasks associated with the targeted credits.

11. The method of claim 8, further comprising a step of generating a limited ratings per day for accomplishing the one or more health related tasks by the user.

12. The method of claim 8, further comprising a step of redeeming the rewards transmitted by the web based server unit to the user account at one or more pharmaceutical stores, and a participating store.
